(19) United States
(12) Patent Application Publication
(10) Pub. No.: US 2007/0013873 A9
(43) Pub. Date: Jan. 18, 2007

(54) Low cost portable computing device

(76) Inventors: Joseph M. Jacobson, Newton, MA (US); Nicholas Negroponte, Boston, MA (US)

Correspondence Address: CHARLES G. CALL, 68 HORSE POND ROAD, WEST YARMOUTH, MA, 02673-2516, US

(21) Appl. No.: 10/894,610

(22) Filed: Jul. 20, 2004

Related U.S. Application Data
(60) Provisional application No. 60/566,307, filed on Apr. 29, 2004.

(51) Int. Cl. G03B 21/26

(52) U.S. Cl. 353/30

(57) ABSTRACT

A very low cost computer comprising a motherboard socketed to receive selected components including a processor, memory modules, and interface controllers for connecting to peripheral devices, in combination with a micro-projection display system. The display system employs a low resolution imaging device such as a transmissive or reflective spatial light modulator in combination with an image deflection system for dithering a sequence of low resolution images from the imaging device as a composite high resolution image directed to either a front or rear projection screen. The system may be used in laptop computers and other portable electronic devices such as PDAs and cellular telephones, and in eyeglass-mounted displays.

### CROSS REFERENCE TO RELATED APPLICATIONS

This application is a Non-Provisional of U.S. patent application Ser. No. ______ entitled “Low Cost Computing Device” filed on Apr. 29, 2004, the disclosure of which is incorporated herein by reference.

### FIELD OF THE INVENTION

The present invention relates to low cost portable computers and to low cost projection display devices for use in low cost computers and in other applications.

### BACKGROUND OF THE INVENTION

The idea of a portable computer comprising a processor, display, memory and input means dates to the Dynabook, originally called the Flex Machine and first described by Alan Kay in 1968. Since then, improved technology has allowed the current generation of laptops and notebook computers to run full operating systems, video and other computing processes that are typically available on larger desktop machines. Although significant progress has been made in the capabilities of portable machines, one significant element, cost, still represents a very large barrier to the acquisition of such portable computing machines to a large fraction of the global population. Today, laptop and portable computers are typically considerably more expensive than desktop computers having comparable capabilities.

A leading contributor to the cost of laptop and notebook computers is the cost of the display. In an effort to reduce the cost and weight of portable computers, the substitution of a projector for the conventional display screen has been proposed. U.S. Pat. No. 5,483,250 issue to Herrick (Zeos) on Jan. 9, 1996 describes a laptop or notebook computer having a housing with a hinged display screen for displaying video images and a built in video projector mounted in the computer housing for projecting an image on the screen. The projector is similar to those utilized in big screen television sets, but microminiaturized for a laptop computer or notebook computer, and similar in electro-optical structure to hand-held micro-miniature televisions. U.S. Pat. No. 5,510,806 issued to Busch (Dell) on Apr. 23, 1996 describes a portable computer using an LCD projection structure that includes a lens housing, a small LCD projection panel supported on an underside portion of the lens, and a high intensity light source supported beneath the LCD projection panel that causes the image to be projected in magnified form onto the raised screen panel. U.S. Pat. No. 5,658,063 issued to Nasserbakht (Texas Instruments) on Aug. 19, 1997 which describes a “monitorless video projection device” that may be built into a laptop computer or the like and uses digital micro-mirror devices “DMD” in a projection system for projecting video images onto a surface.

While CRT, LCD and DMD devices that generate two dimensional images have been widely and successfully used in high resolution video projection systems, including high definition television displays, when such devices are capable of presenting images having the resolution and quality of a thin film transistor (TFT) LCD panels now in common use in laptop computers, they have proven to be as expensive or more expensive than TFT displays.

Other projection systems have been developed that employ a single, intensity-modulated spot of light (here termed a “0D” system) that is scanned horizontally and vertically across the field of view. U.S. Pat. No. 3,437,393 to Baker et al. discloses a display system for projecting a beam of light from a laser source using rotating mirrors to form a two-dimensional scan pattern. U.S. Pat. No. 5,727,098 issued to Joseph M. Jacobson on Mar. 10, 1998 describes a display system that includes an image light source for producing a modulated light, an optical fiber coupled at one end to the light source, and a deflection device for vibrating the second end of the optical fiber in a two-dimensional scan pattern to project an image onto a viewing surface. Other “1D” systems scan a row of light sources forming a line in a direction perpendicular to the line to form a two-dimensional display. U.S. Pat. No. 3,958,235 to Duffy discloses a display system having a linear array of LEDs disposed on a cantilever member that is vibrated in an arc at a predetermined rate while selected LEDs are energized for producing a two-dimensional display. U.S. Pat. No. 4,311,999 to Upton et al. discloses a display system having a plurality of light emitting sources coupled to a linear array of optical fibers. The array of optical fibers is vibrated in a direction which is perpendicular to the axis of the linear fiber array for producing a two-dimensional display. U.S. Pat. No. 5,982,553 issued to Bloom et al. on Nov. 9, 1999, describes a 1D display system using a reflective grating light-valve (GLV) array produced by Silicon Light Machines that provides a one dimensional array of pixels from a row of spaced-apart, elongated movable reflective-members aligned parallel to each other. U.S. Pat. No. 4,311,999 to Upton et al. discloses a display system having a plurality of light emitting sources coupled to a linear array of optical fibers. The array of optical fibers is vibrated in a direction which is perpendicular to the axis of the linear fiber array for producing a two-dimensional display.

These “0D” single spot and “1D” linear array displays suffer, however, from the need to employ extremely fast scan and modulation times which can be technically difficult and expensive to manufacturer, particularly in small form factors. There is accordingly a continuing need for a lower cost high resolution display device which can be used in small portable computer.

There is a further need to provide an architecture for a low cost computer incorporating a projection display that can be employed in a variety of different computing devices having different capabilities and that can be mass produced to reduce costs.

### SUMMARY OF THE INVENTION

In one preferred embodiment, the present invention takes the form of an image projector in which a sequence of two dimensional images each composed of an array of M elements in a first dimension and N elements in the other dimension, where N is greater than M and where M is greater than one, are projected onto a target displaced from one another in the first dimension. The projection system includes an image deflection mechanism that displaces the sequence of images by differing amounts to produce a composite image composed of interleaved lines of N elements each.

The source of the two dimensional images includes a spatial light modulation device individually controlling the light intensity of each of image element. The spatial light modulator may be a transmissive device through which light passes from said source to said target, or an imaging device for selectively reflecting light from said source onto said target.

The image deflection mechanism for displacing the images projected onto the target surface may comprise means for physically deflecting the imaging device that creates the image or some other device that determines the optical path of the projected image, or may comprise a light deflection device such as electro-optical beam steering device for altering the direction at which light is projected onto said target.

The invention may be used to advantage to form the display system of a portable computer consisting of the combination of a motherboard adapted to support and interconnect an integrated circuit microprocessor, one or more random access memory modules, one or more peripheral device controllers, and a graphics output controller, and a display system comprising a light source, a spatial light modulator for controlling the intensity of light from said source at each pixel position of an image consisting of a two dimensional array of pixels, and an optical projecting system for directing the image onto a visible screen surface by means of a mechanism for displacing the two dimensional image in one of said dimensions to form a higher resolution image on said target

The projection system employed in the laptop may form a front projection system in which the image is directed onto the front of the display screen, or a rear projection system in which the image is directed against the rear of a translucent screen. The optical projection path may be folded, or may utilize an optical wedge to project the image onto the target screen. The screen may be contracted when not in use and expand to form a large visible area during use, and means may be employed to automatically adjust the size of the projected image to correspond to the changing screen size. A piezoelectric transducer may be incorporated into the screen or be positioned behind or adjacent to the screen to provide audio output.

The present invention provides a novel architecture for a very low cost portable computing machine in which an motherboard (with user accessible ports) upon which electronic components are mounted is combined with a micro-projector which in their agglomerate comprise a Projector Motherboard Engine (PME). This PME architecture may additionally comprise a case, a power supply, input means and a screen for projection of the micro-projector. The Projector Motherboard Engine (PME) architecture allows for a significant manufacturing cost savings as compared to current portable computing machines as it replaces one of the costliest components, the flat panel display with a less costly component, a micro-projector. In addition, the use of an open source hardware framework into which users can plug in their own selected processor, memory and other components allows a very high level of customizability on the part of the user as well as the potential for a wide variety of form factors (e.g. different screen sizes) based on the same architecture. This feature in turn allows further significant cost reductions as a very high volume of the basic PME board may be manufactured to fill a wide variety of finished product form factors.

### BRIEF DESCRIPTION OF THE DRAWINGS

In the detailed description which follows, frequent reference will be made to the attached drawings, in which:

FIG. 1 is a block schematic diagram of a combined motherboard and projection display engine which embodies the principles of the invention;

FIG. 2 is an illustration of a low cost projection system including means for scanning the image produced by a low resolution transmissive display device to form a projected high resolution display;

FIG. 3 is an illustration of a low cost projection system including means for scanning the image produced by a low resolution reflective display device to form a projected high resolution image.

FIGS. 4A and 4B respectively illustrate the conventional and modified pixel position layouts of a low resolution two-dimensional imaging device that may be used in combination with an image scanning mechanism to yield a high resolution image;

FIG. 5 shows the pixel layout of a low resolution imaging device which compensates for keystoning effect created during image projection;

FIG. 6 is a simplified perspective view of a laptop computer using a front projection display;

FIG. 7 is a simplified perspective view of a laptop computer using a folded optics projection display;

FIG. 8 is a simplified perspective view of a laptop computer using a stalk mounted front projection system;

FIGS. 9 and 10 show a laptop computer which an expandable projection screen shown in its contracted and expanded positions respectively;

FIG. 11 s a simplified perspective view of a laptop computer using a rear projection display;

FIG. 12 is a simplified perspective view of a laptop computer using multiple overlapping front projectors;

FIG. 13 is a simplified perspective view of a laptop computer employing plural rear projectors;

FIG. 14 is a simplified perspective view of a laptop computer using plural projectors and wedge optics to create a thin rear projection screen;

FIG. 15 is a simplified perspective view of a laptop computer in which the displayed image is projected over the keyboard and the user's hands;

FIG. 16 is an overhead cross-sectional view of an eyeglass supported display which using a 1.5D projection system; and

FIG. 17 illustrates the use of the invention to provide a projected display from a cellular telephone.

### DETAILED DESCRIPTION

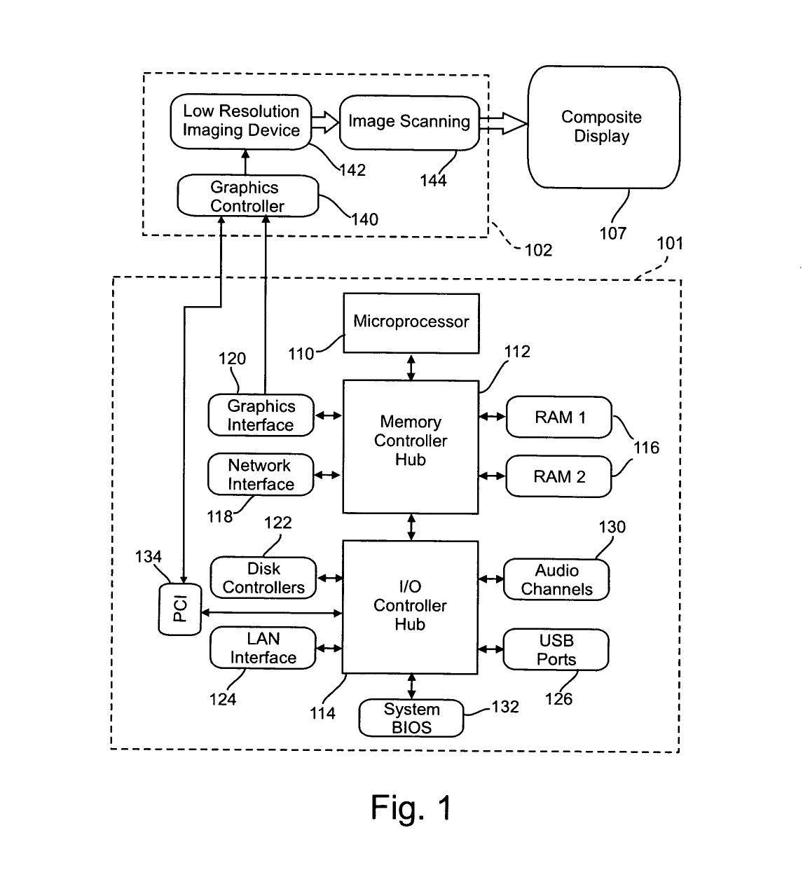

The present invention is preferably implemented using the combination of personal computer motherboard and a microprojector engine. FIG. 1 is a block diagram of the combined motherboard, indicated at 101, and microprojector, seen at 102, which projects an image on a display screen 107.

The components mounted on the motherboard 101 are conventional and the specific arrangement shown in FIG. 1 and described below is merely illustrative of one available, highly functional arrangement that is mass produced at low cost. The motherboard 101 consists of a chipset, such as the Intel 875p chipset, which coordinates the operation of an processor, such as an Intel Pentium 4 processor, seen at 110 and various peripheral devices using two controller hubs: a memory hub controller (e.g. Intel 82875P MCH) seen at 112 and an I/O Controller Hub (e.g. Intel 82801EB ICH5R) seem at 114.

The memory hub controller 112 connects the processor 110 and other devices to up to 4 Gigabytes of high speed random access memory (e.g. dual channel DDR400, DDR332 SDRAM) seen at 116. The memory controller hub 112 also provides external devices with high speed access to RAM via a Dedicated Network Bus (DNB) seen at 118 than includes provision for a Gigabit Ethernet communications pathway. An Accelerated Graphics Port (Intel AGP8X) indicated at 120 provides direct access between high speed RAM at 116 and a graphics controller, such as the controller 140 used in the microprojector engine.

The I/O Controller Hub 114 provides data pathways to disk and optical memory units via Serial ATA interface as indicated at 122. Lower speed networks can be connected via the LAN interface 124, and to eight high-speed USB 2.0 ports are provided as seen at 126 which provides high speed connections for input devices such as a mouse, trackpoint, trackpad and/or a keyboard, as well as printers, scanners, cameras, and external memory devices Up to six enhanced audio channels are provided as seen at 130 to support digital 5.1 surround sound. The I/O controller hub also provides a connection to a read-only memory module at 132 which stores the system BIOS.

The components of the motherboard 101 are preferably mounted on a single printed circuit board (e.g. the Intel Desktop Board D875PBZ) which provides sockets for a variety of different processors, different amounts and types RAM storage 116 on DIMMs (dual inline memory modules), and PCI expansion slots seen at 134 for custom configurations, add-in card upgrades, and an alternative lower speed PCI connection to a graphics controller that provides the output display.

While minimizing the cost of a portable computer can make computing affordable for many who cannot afford a conventional computer, even a very low cost computer is of little use in locations where electrical power is unavailable. To meet this need, the motherboard and microprojector may be combined with a human-powered, spring-driven generator to provide a “wind-up” power supply for the computer. See, for example, U.S. Pat. No. 5,668,414 issued to Takahash et al. (Seiko Epson Corp.) on Sep. 16, 1997 entitled “Spring driven electricity generator with a control circuit to regulate the release of energy in the spring,” the disclosure of which is incorporated herein by reference. The wind-up power supply may be used in combination with solar cells mounted externally or on the laptop case to charge a laptop battery.

In accordance with the invention, the low cost, mass produced motherboard 101 is combined with a low-cost microprojector engine which may be mounted directly on the motherboard or may form a separate module which includes a graphics controller 140 that is connected to the mother board via a PCI slot 134 or the higher speed AGP port 120 The graphics controller feeds image data to a low resolution imaging device 142, described below, which produces a low resolution, small area image covering that is then scanned over a larger area by an image scanning mechanism 144 to yield the desired high resolution composite image 107.

The principles of the invention may be employed to advantage in connection with a wide variety of existing imaging and image projection technologies. In the description to follow, it will be noted that the invention may be incorporated into or employed to modify existing devices described in a number of representative previously issued patents, the disclosures of which are incorporated herein by reference.

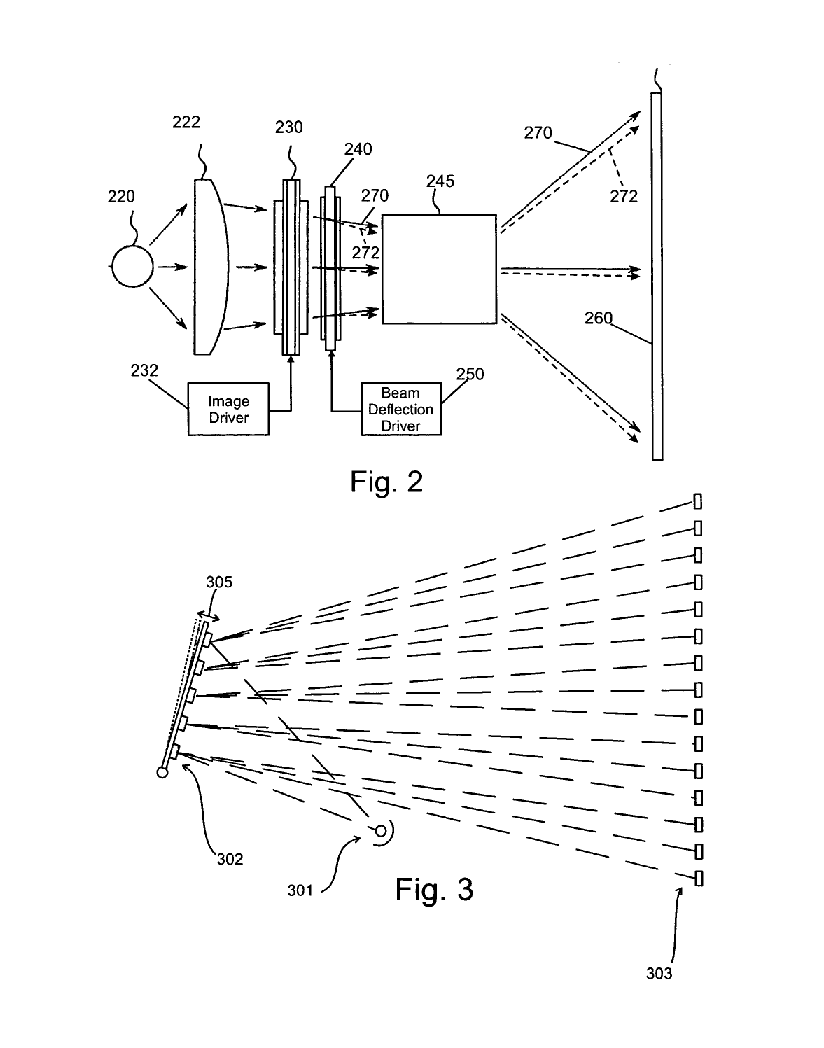

The low resolution imaging device 143 employed in the microprojector 102 may take a variety of forms, including both transmissive and reflective devices. FIG. 2 illustrates a transmissive LCD display element in a projection system of the type disclosed in U.S. Pat. No. 6,409,350 issued to Kakimoto et al. (Matsushita Electric) on Jun. 25, 2002, the disclosure of which is incorporated herein by reference, in which light from a source 220 is collected by a lens 222 and directed through an LCD panel 230 that acts as a transmissive spatial light modulator (SLM). An optoelectric beam deflection grating 240 and a projection lens 245 direct scanned image light from the LCD panel 230 onto a front projection screen 260. The LCD SLM panel 230 varies the light intensity at each pixel position in a relatively low resolution two-dimensional array under the control of a data signal supplied by an image driver 232.

The image produced by the low resolution LCD panel 230 may be dithered either vertically or horizontally, and the desired beam deflection can be achieved either mechanically or electro-optically. Such a small displacement can be carried out with a very low cost piezoelectric actuator which deflects an imaging wafer or a mirror in the optical path, as described below in connection with FIG. 3, or electrooptically using a beam deflection device 240 such as an electro-optic holographic “DigiLens” available from SBG Labs Inc., 1288 Hammerwood Avenue, Sunnyvale, Calif., 94089. A DigiLens® is a thick volume phase grating in which the grating strength (index modulation) can be varied by means of an applied electric field from a deflection driver 250. The grating strength can be reduced to near zero, so that such that the element can be switched to an essentially transparent state, so that the image light is directed along the path seen at 270 in FIG. 2. As the applied field is increased, a light beam passing through the grating 240 can be steered to the deflected path seen at 272. By applying different field strengths to the grating, the beam can be deflected (dithered) by different amounts to achieve the desired number of interlaced lines of pixels in the projected high resolution image.

U.S. Pat. No. 5,692,820 issued to Gale et al. (Kopin Corporation) on Dec. 2, 1997, the disclosure of which is incorporated herein by reference, describes a further example of a projection monitor in which a small liquid crystal display (LCD) is used in combination with either an incandescent or arc discharge light source such as a short arc xenon lamp to direct an image onto a rear projection screen. Alternatively, the low resolution imaging device may be a reflective device, such as the “DMD” digital mirror device described in U.S. Pat. No. 5,515,076 issued to Thompson et al. (Texas Instruments) on May 7, 1996, the disclosure of which is incorporated herein by reference. A second embodiment of the invention employing such a reflective imaging device is illustrated in FIG. 3. Light from a source 301 reflects off each pixel location in the low resolution array 302 to illuminate a corresponding pixel position in the composite display 303. The low resolution array 302 may take the form of a single integrated circuit which is itself physically deflected by an actuator (not shown) as indicated at 305 so that the reflected light from each pixel location is directed to one of three different target locations depending on the current angle at which the low resolution array is deflected. In the arrangement shown in FIG. 3 which uses a “dithering ratio” of three, the composite image has three times as many pixel locations as the low resolution display.

The light source, seen at 141 in FIG. 1, at 220 in FIG. 2, and at 301 in FIG. 3 may be an arc lamp, a xenon lamp, a mercury lamp, an incandescent lamp, an LED or a laser. Further, a fixed white light source may be used in combination with color filters, or may consist of a color switchable source in which case the color switching is be synchronized to the display device, may be employed to produce a full color projected image.

The cost of producing two dimensional imaging devices typically varies in proportion to the size of the chip die. In order to have the lowest cost the die size should be kept as small as possible. In addition, in a high resolution device, the pixel size must correspondingly be made small. There are however limitations to the minimum size of the pixel which can be realized (e.g. smallest size is approximately 4 microns for an LCD and about 12 microns for a digital mirror device.

As contemplated by the present invention, the objective of producing a low cost display of adequate resolution for use in a low cost portable computer can be better achieved by employing a single chip to produce a two-dimensional image of relatively low resolution, and using an image deflection mechanism to scan the low resolution image in one dimension to form the desired high resolution image.

By dithering the low resolution display to form a high resolution display, a much lower cost display chip may be used in combination with a relatively inexpensive image scanning mechanism to dramatically reduce the overall cost of the display. For example, a microdisplay device having ¼th the resolution of a VGA device can be provided at a cost between $5 and $10 dollars, but its output can be scanned to form a composite image having a resolution equivalent to a full XGA display at a significantly lower cost than a native XGA display chip.

Tables 1 and 2 below illustrate how a very low cost, low resolution chips may be converted to an XGA chip. For this example the numbers in the tables refer to a black and white (or color sequential display).

TABLE 1

| | Type | | | |
|---|---|---|---|---|
| | ¼ VGA | VGA | SVGA | XGA |
| Layout (X-Y) | 320-240 | 640-480 | 800-600 | 1024-768 |
| Pixel Spacing (microns) | 10 | 10 | 10 | 10 |
| Display Diagonal | 0.16 | 0.31 | 0.39 | 0.50 |
| (inches) | | | | |
| Display Area | 0.01 | 0.05 | 0.07 | 0.12 |
| (sq. inches) | | | | |

As shown in Table 1 above, a ¼ VGA chip in its standard layout consists of 320×240 pixel layout (as illustrated in FIG. 3) for a total of 76,800 pixels. A full VGA chip doubles both the X and Y dimensions to 640×480 and has four times as many pixels: 307,200. An SVGA chip forms an array of 800×600 pixels for a total of 480,000. An XGA chip provides a resolution of 1024×768 and a total of 786,432 pixels. As shown in Table 1, with a distance between pixels of 10 microns, the ¼ VGA display die occupies an area having a diagonal dimension of 0.16 inch and an area of 0.1 inches, whereas the XGA display die has a diagonal dimension of 0.5 inch and occupies an area of 0.12 inches.

Since the cost of a chip die scales as its area (exclusive of drivers which scale as the total number of address lines), a chip with the same total pixel count as the ¼ VGA chip could be laid out as 1024×75 pixels as illustrated in FIG. 3. If the pixel size for such a chip were 10 microns and the chip were dithered by an image scanner about 10×, such a configuration would yield a composite image having a layout of 1024×750 which closely approximates the resolution of an XGA display. The total chip die area would be about 1/10 that of an XGA chip (exclusive of driver circuitry) and would accordingly be substantially less expensive.

TABLE 2

| | Normal | Wide | Imaged | Dithering | Output | Output |
|---|---|---|---|---|---|---|
| Type | X-Y | X-Y | Pixels | Ratio | X-Y | Pixels |
| ¼ VGA | 320-240 | 640-120 | 76,800 | 4 | 640-480 | 307,200 |
| ¼ VGA | 320-240 | 800-96 | 76,800 | 6 | 800-576 | 460,800 |
| ¼ VGA | 320-240 | 1024-75 | 76,800 | 10 | 1024-750 | 768,000 |
| VGA | 640-480 | 800-384 | 307,200 | 2 | 800-768 | 614,400 |
| SVGA | 800-600 | 1024-469 | 480,256 | 2 | 1024-938 | 960,512 |
| XGA | 1024-768 | | 786,432 | | | |

Alternative chip layouts and dithering ratios are shown in Table 2, above. A chip having the resolution of a ¼ VGA chip could have a 640×120 layout and employ a dithering ratio of four to yield a 640×480 output layout having a resolution equivalent to a VGA chip. The ¼ VGA chip alternatively could be laid out in a 800×96 pixel pattern and use a dithering ratio of six to yield a composite image having a resolution of 800×576 pixels to approximate the resolution of an SVGA chip.

A chip having a resolution equivalent to a 640×480 VGA chip could have a layout of 800×384 pixels and employ a dithering factor of two to yield a resolution of 800×768 pixels to approximate the resolution of an SVGA chip. Alternatively, a VGA equivalent having a 1024×300 layout could be used with a dithering factor of three to yield a composite image having a resolution of 1024×900 pixels, approximately the same as an XGA chip. Finally, an SVGA chip could have a layout of 1024×469 which, if dithered into two images, would produce a composite resolution of 1024×768 pixels equal to the resolution of an XGA chip.

Note that, in every instance, these layouts and dithering ratios have the following common features:

A. The number of pixel locations along one dimension of the low resolution chip layout is the same as the corresponding pixel dimension of the desired composite image. This eliminates the need to dither the image in more than one dimension, simplifying the scanning mechanism.

B. The number of pixel locations in the other dimension of the low resolution display is large enough to reduce the number of separate dithered locations that must be generated by the scanning mechanism to a number that can be supported by available scanning techniques. The largest dithering factor shown in Table 2 above is ten, and the mechanism for scanning the low resolution image into 10 adjacent pixel locations could be either electrooptical, such as the Digilens (r) electrically controlled diffraction grating, or mechanical, such as an electromechanical actuator used to move the low resolution chip or a reflecting mirror. For example, with the largest dithering ratio of ten shown in Table 2, above, an actuator need only produce an excursion of 100 microns (10 microns×10× dither) at a frame rate of 600 Hz (60 Hz×10× dither), both of which are easily achieved with low cost piezoelectric and other scanning elements. In order to implement the above approach, a microlens array would initially map each longer pixel column in the display chip to be D pixel lengths away from the adjacent longer pixel column where D is the dithering ratio. In this way, a sequence of D-1 dithered pixel columns can be inserted between each pixel column in a single image from the device.

C. In each single “frame” of the high resolution output image, each single column of pixel locations on the display chip generates a timed sequence of D adjacent, spaced-apart, scanned lines of pixels in the output image where D is the dithering ratio, and repeats this timed sequence for each subsequent frame of the output image.

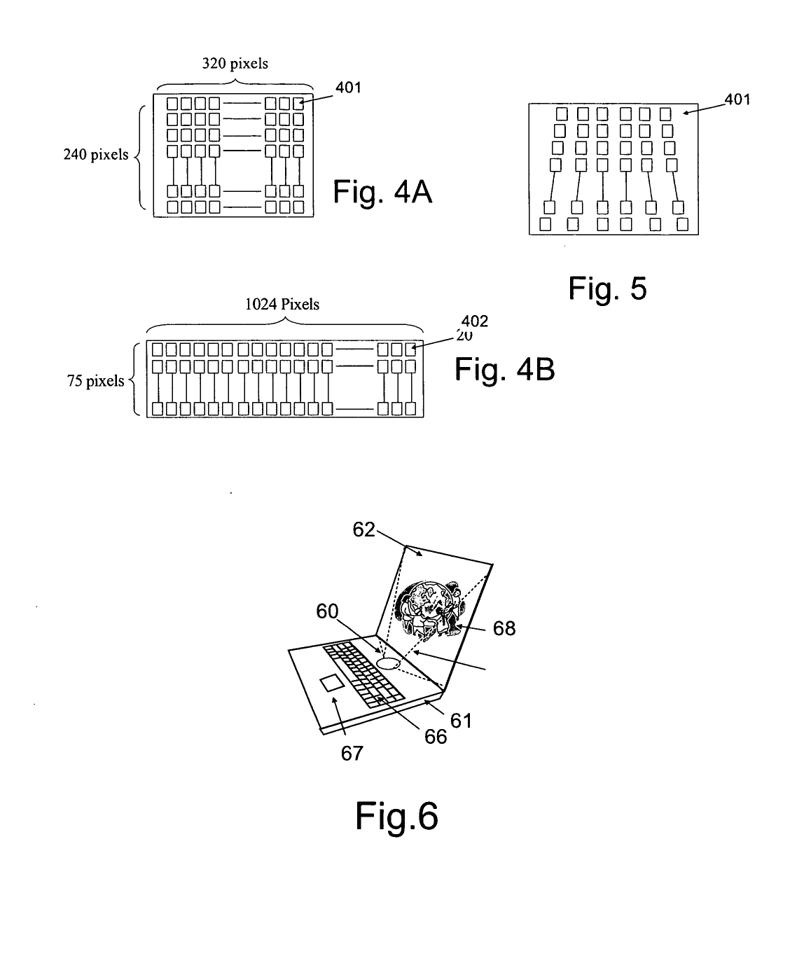

The layout of pixels on the display chip may be pre-aliased as illustrated at 501 in FIG. 5 such that the resulting image does not exhibit a ‘keystone’ artifact even at high projection angles.

The low cost projection display system contemplated by the present invention may be used to dramatically reduce the cost of a laptop or notebook computer. Conventional laptop computers are heavy, expensive and draw substantial power due in significant part due to the weight, cost and power consumption of the commonly employed thin film transistor (TFT) liquid crystal display (LCD) technology most commonly used. Although many of the components of a conventional laptop, such as disk drives, may be common to many types of laptops and thus can be manufactured at the highest manufacturing volumes (and thus lowest costs), the display and other components of the conventional laptop require customization dependent on the form factor of the particular laptop and cannot be manufactured in the highest volumes. By using the combination of the reduced cost 1.5D display system described above in combination with a mass produced motherboard, here jointly called the “Projector Motherboard Engine,” may be used in laptops and other computers of many different configurations and capabilities, and hence the components implemented by the Projector Motherboard Engine may be produced much lower cost.

FIGS. 6-14 show a number of potential alternative configurations for a laptop portable computer employing the Projector Motherboard Engine (PME) architecture. Not all aspects or features presented in each layout configuration be incorporated in each implementation and each feature illustrated should be viewed as separable from each other feature.

FIG. 6 illustrates a laptop computer in which the projector at 60 is used to display a high resolution image along beam pathways 61 onto a front projection screen 62. The body 65 of the laptop computer houses a motherboard and projector of the kind illustrated in FIG. 1, and further includes a keyboard seen at 66 and a touchpad control at 67. The high resolution image 68 projected on the screen 62 is a composite formed by scanning (dithering) the two-dimensional image from a relatively low resolution imaging device as discussed above. The screen 62 may advantageously take the form of Lambertian reflective surface or other type of scattering reflecting surface, or may be a high gain glass beaded screen of the type manufactured, for example, by Da-Lite Screen Company, Inc., Warsaw, Ind. The surface of screen 61 may alternatively form diagonally oriented microridges so that the optical beam from the projector 60 projects an image at high angle onto the microridges and the light is then reflected from the microcorrugated surface at an angle more locally normal to the surface than would be the case for a flat surface, thus improving reflected efficiency for high angle projection.

In addition, the screen 61 may be piezoelectric, or may incorporate a piezoelectric element or elements positioned within or behind the screen, to provide a speaker for audio output.

In a standard configuration, the screen 62 may be mounted on a hinged backing as shown in FIG. 6 such that the screen can fold over the keyboard portion of the laptop to form a protective cover. In another configuration, the screen 62 may fold backward out of the path of the image light from the projector 60 which may be directed to another surface such as another screen or onto a wall. In such applications, an additional exogenous light source may be used to illuminate the display chip in the Projector Motherboard Engine. For example, an exogenous light source may be plugged onto a slot in the laptop and a suitable optical coupling, such as a fiber optic waveguide, may be used to couple light from the exogenous light source to the display chip.

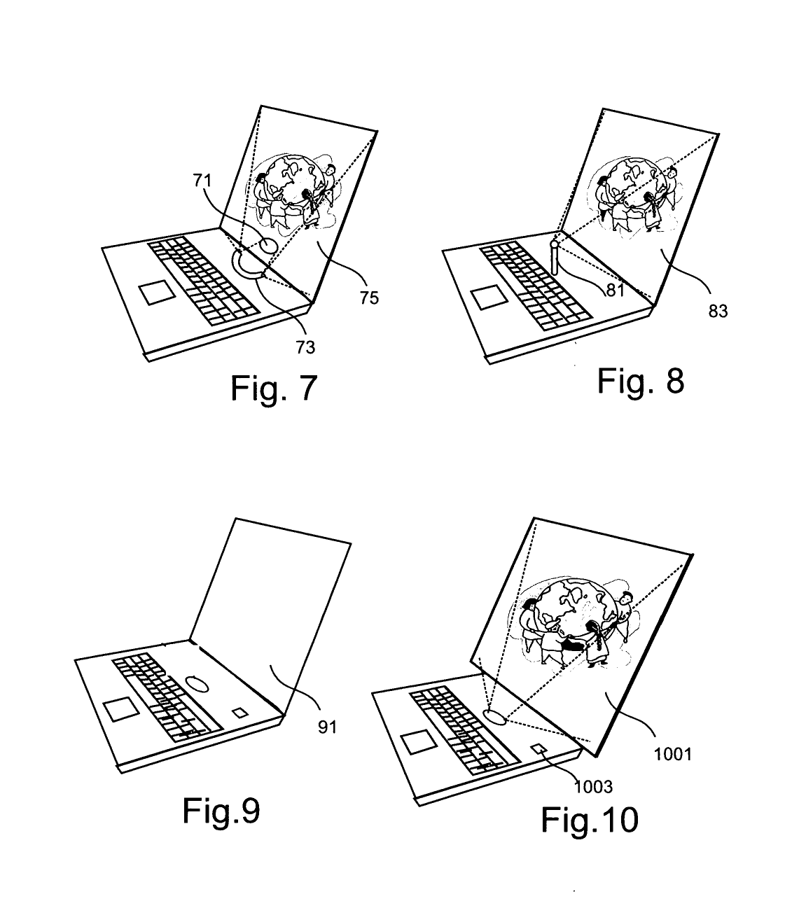

FIG. 7 shows an alternate embodiment of a laptop computer employing a folded optics system in which the image an image is projected from a source 71 onto a reflective optic element 73 which in turn reflects the image onto a screen 75. The use of folded optics scheme has particular utility for very short throw lengths encountered in laptop geometries.

FIG. 8 illustrates a laptop computer in which the image is projected from a stalk 81 onto a screen 83. The stalk 81 may be conveniently located within or near the keyboard area and be arranged to pop up when the laptop lid carrying the screen 83 is opened.

FIGS. 9 and 10 shows a laptop employing a variable sized front projection screen which expands from a smaller size as seen in FIG. 9 at 91 to a larger size seen in FIG. 10 at 1001. The screen may be constructed of an elastomeric material formed by mixing highly reflective scattering materials such as Titanium Dioxide light scattering particles (˜150 nm in size) into a suitable elastomer such as Polydimethyl Siloxane (PDMS). Such a screen may be mounted on a suitable variable mechanical mount which has the ability of be configured into multiple sizes, thus stretching the elastomeric screen material. By way of example, the screen may start in a smaller size configuration 91 when folded to cover the keyboard portion of the laptop. When opened, the screen may deploy to a larger size configuration to present a larger viewing surface. Such an arrangement allows a relatively small laptop to have a relatively large viewing screen. In each case the size of the image projected by the projector 40 may be adjusted either manually or automatically to correspond to the physical size of the screen. Automatic adjustment can be effected by means of sensors such as potentiometers, optical sensors or other sensors which measure the size of the deployed screen and adjust an optical component such as a motorized or electrooptical or electrofluidic zoom lens in front of the projector, and may also vary the extent of dithering of the projector such that the image size is matched to the screen size.

A CCD or CMOS imaging element seen at 1003 in FIG. 10 may be used to sense characteristics of the image projected on to the screen to provide feedback to the projector optics, dithering controls and/or image controls to correct aliasing, keystoning and image size appropriate for a given screen size and deployment angle. The same CCD or CMOS imaging element or other imaging elements may be used to detect the position of a finger or a stylus proximal to the screen as a means of input to the computer to provide “touch screen” capabilities.

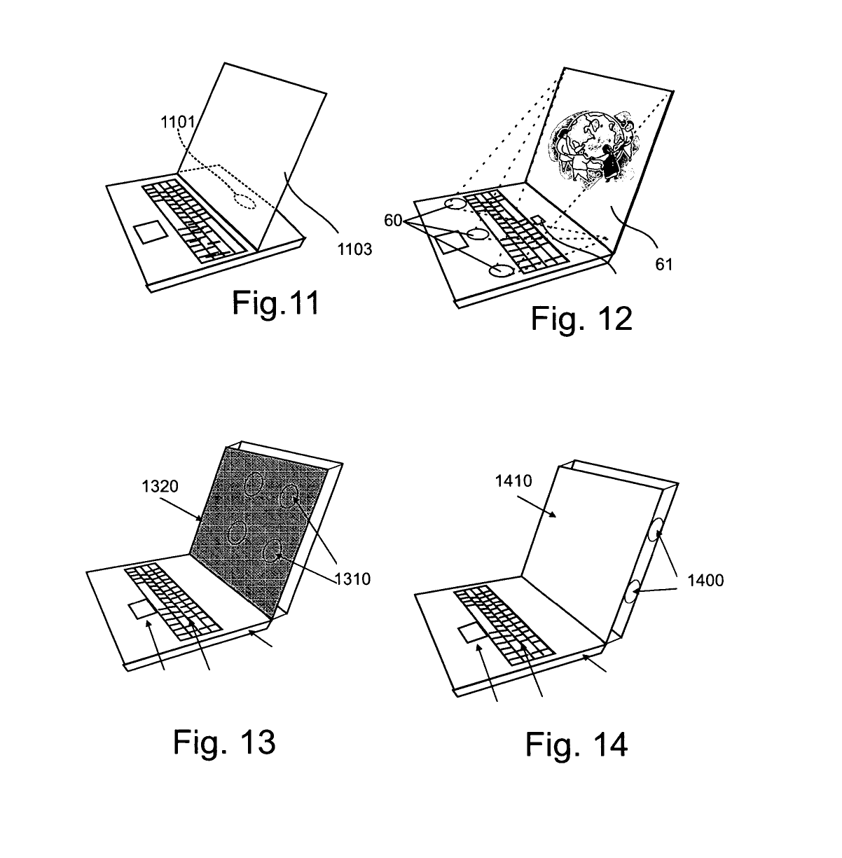

FIG. 11 shows a schematic of a laptop computer employing the microprojector engine motherboard in a rear projection screen system. The rear projection screen seen at 1101 may be a normal diffusive rear projection screen or may be a high gain rear projection screen comprising either fresnel lenses, lenticular lenses or both on one or each surface for the purpose of directing more light along the axis of projection. By way of example, U.S. Pat. No. 6,728,032 issued to Peterson et al. (InFocus Corporation) on Apr. 27, 2004, the disclosure of which is incorporated herein by reference, describes a rear projection display system in which the screen includes angularly discriminating reflective elements configured to reflect light incident on the screen from a first angle toward the rear reflector, and to allow light incident on the screen from a second angle to be transmitted through the screen for display. See also, U.S. Pat. No. 6,671,093 issued to Nakamura (Olympus Optical Co.) on Dec. 30, 2003, the disclosure of which is incorporated herein by reference, which describes a transmissive rear projection screen in which a lenticular lens sheet forming a lens surface is arranged on the incident side of the screen.

FIG. 12 illustrates a further laptop configuration employing multiple projectors seen at 1201 used with a front projection screen 1203. Such an arrangement when coupled to feedback from a CCD or CMOS imaging element or other imaging element 90 to control said multiple projectors as noted above can be used synthesize and project a continuous image on screen 100 even if one or more projectors are being occluded as by the hands of the user for instance. Such a system works if there is at least one copy of each pixel in a given image amongst the multiple projectors which is free of occlusion.

FIG. 13 shows another alternate embodiment of the present invention comprising a laptop computer 1301 having a keyboard 1303, a touchpad 1305, and multiple rear projectors indicated at 1310 which produced a combined image on a rear projection screen 1320. This embodiment provides the combination of a relatively thin rear projection screen with several integrated projectors. Integrated projectors are desirable in certain applications as no free space throw of the projected image is required thus obviating any obstruction of the thrown image (e.g. by the user's hands). U.S. Pat. No. 6,561,649 issued to Burstyn (Sarnoff Corp.) on May 13, 2003, the disclosure of which is incorporated herein by reference, discloses a compact rear projection system using birefringent optics that reduces cabinet depth by folding the optical path with polarization sensitive mirrors. However, practical optics limit the minimum distance required to throw an image of a given size thus limiting the minimum distance between a single projector and a projected image of given size. The embodiment of FIG. 13 enables a relatively thin rear projection screen with directly mounted projectors 1310. The thinness of the resulting screen structure results from the fact that each projector need only throw an image a fraction of the size of the total image size.

FIG. 14 shows another embodiment of the present invention incorporates a type of optical element known The Wedge® display developed by Cambridge Flat Projection Displays LTD. This device maps incident angle to distance along an optical screen consists of a wedge-shaped piece of glass or plastic is than 1 cm thick coupled to a video projector. As described in U.S. Pat. No. 6,002,826 issued to Veligdan (Brookhaven Science Associates) on Dec. 14, 1999, the disclosure of which is incorporated herein by reference, a thin display optical projector of this type employs an optical system that projects light into a planar optical display using laminated optical waveguides that define an inlet face at one end and an outlet screen at an opposite end, and uses mirrors to collimate the light. Similarly, U.S. Pat. No. 6,636,355 issued to Moshrefzadeh et al. (3M Innovative Properties Co.) on Oct. 21, 2003, the disclosure of which is incorporated herein by reference, describes a microstructered rear projection screen that includes a plurality of tapered waveguides and a light absorbing layer disposed over the tops of the waveguides. Such optical elements are usually used for large flat screen televisions and monitors. One issue with such displays is that the use of light which usually comes from a large projector is not very good. In accordance with the present invention, considerably better usage of light can be obtained if the display chip width is matched to the width of the wedge. Such a task may be difficult to achieve in cases requiring a high resolution display as the size of the chip is too large. In the case of the present invention, such a task may be accomplished by using a 1.5D chip which is dithered. The smaller chip die that is employed is more readily matched to the wedge thickness. Alternatively, multiple lower resolution chip die as indicated in FIG. 14 at 1400 may be optically coupled to a wedge optical component to form a flat panel display suitable 1410 suitable for laptop applications. As with the other laptops seen in FIGS. 6-13, the laptop shown in FIG. 14 includes a main housing 1420 that houses a motherboard containing a processor coupled to external devices such as the keyboard seen at 1425 and the touchpad seen at 1430.

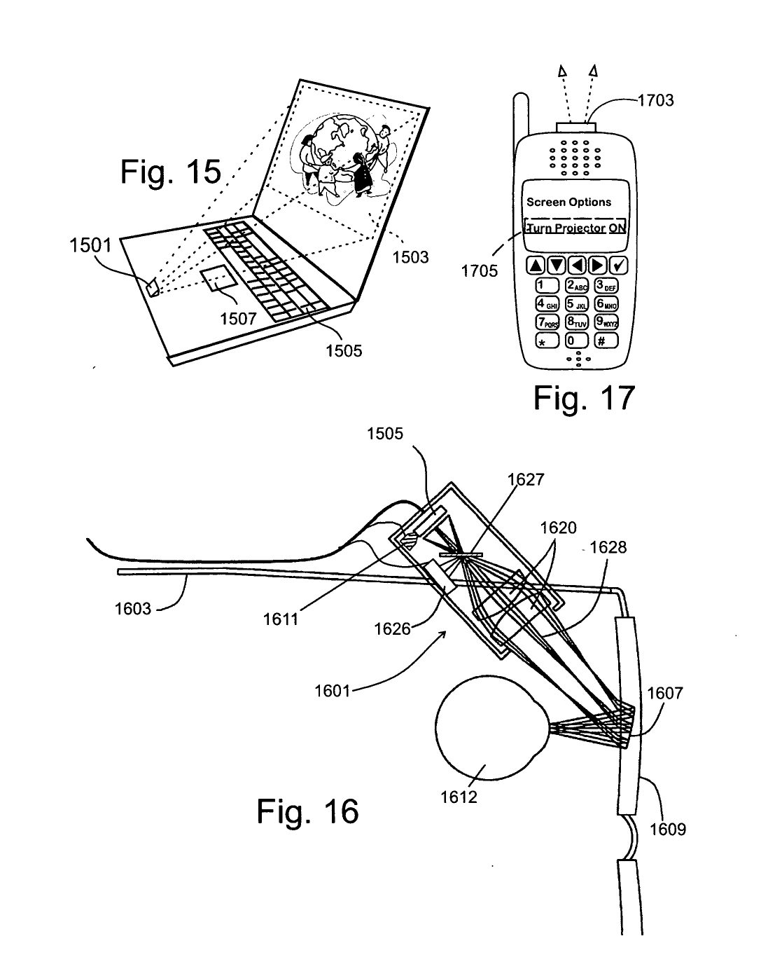

FIG. 15 illustrates still another embodiment of the invention in which the projector is positioned at 1501 at the front of the laptop's work surface (nearest the user's body) and projects an image onto the screen area seen at 1503. The image may have a 16×9 aspect ratio and is projected toward the top of the display panel provided by the laptop's raised lid. The projection lens may be pivotally mounted so that it flips up into a raised position as seen at 1501 but can be returned to a recessed position when the laptop lid is closed. By projecting the image toward the top of the display panel from the central location 1501, the user's wrists are positioned on either side of the lens position 1501 and the image is projected over the keyboard and the user's hands.

The principles of the invention may also be applied to the design and construction of head-mounted display devices of type disclosed in U.S. Pat. No. 6,353,503 issued to Spitzer et al. on Mar. 5, 2002 entitled “Eyeglass display lens system employing off-axis optical design,” the disclosure of which is incorporated herein by reference. Eyeglass mounted displays typically employ 0D and 1D dithered displays and suffer the shortcoming of other such projection displays as discussed above. FIG. 16 illustrates an alternative embodiment to the present invention in which a 1.5D display device indicated generally at 1601 is mounted on the frame 1603 of a pair of eyeglasses and projects an image from a low-resolution, two dimensional imaging device 1605 onto the inside surface 1607 of the eyeglass lens 1609. A piezoelectric actuator seen at 1611 displaces the imaging element in one dimension to dither the reflected image seen by the eye 1612 as projected through the lenses 1620. In addition, eye tracking by means of a 2D imager (e.g. CMOS or CCD imager) at 1625 may be used to control the image of the projected image, such as controlling the local resolution in the direction of gaze or controlling the angle of the projected image (e.g. by means of an additional electromechanical or electrooptical component) to improve the effective field of view. As seen in FIG. 16, the eye tracking imager 1625 may share the same optical lens system used to project the image from the imaging source 1611 by reflecting incoming light via the partially reflective mirror 1627 onto the imager 1625. Head mounted displays with eye tracking systems may be used in flight control, flight simulation and virtual imaging displays. Eye control systems generate information based on the position of the eye with respect to an image on a display and have been used to enable the viewer to control “hands-free” movement of a cursor, such as a cross-hair on the display. Apparatus for detecting the orientation of the eye or determining its line-of-sight (LOS) are called occulometers or eye trackers and are well known in the art. See for example U.S. Pat. Nos. 4,109,145, 4,034,401 and 4,028,725. U.S. Pat. No. 6,636,185 issued to Spitzer et al. (Kopin Corp.) on Oct. 21, 2003, the disclosure of which is incorporated herein by reference, describes a head mounted display using an active matrix liquid crystal display (AMLCD) and further uses a detector array comprising thin film integrated optical diode detectors positioned such that each is completely above the drive transistors of the active matrix circuit i.e., adjacent to the pixel area. In this way, the detector array does not block any of the display's light output and light output from the display, either infrared or visible, is used to determine the position of the eye. No additional optics, such as, fiber optics to/from remote displays are required.

The small size and low cost of the microprojector engine allows it to be used to advantage in small, handheld devices such as PDAs and cellular phones. As illustrated in FIG. 17, the microprojector may be mounted with the housing of the portable device, and may be used to projected a displayed image onto an available surface, such as a wall, a whiteboard, or a portable display screen. The lens may extend outwardly through the housing as indicated at 1501 and may be focused by turning the cylindrical lens extension in the conventional way. The projected image may be used as an adjunct to the device's normal display screen, and may be turned ON and OFF by a programmed menu selection as illustrated at 1705.

### CONCLUSION

It is to be understood that the methods and apparatus which have been described above are merely illustrative applications of the principles of the invention. Numerous modifications may be made by those skilled in the art without departing from the true spirit and scope of the invention.

What is claimed is:

1. An image projector comprising a source of a sequence of two dimensional images each composed of an array of M elements in a first dimension and N elements in the other dimension, where N is greater than M and where M is greater than one, and a deflector for displaying said sequence of images on a target surface displaced from one another in said first dimension.

2. An image projector as set forth in claim 1 wherein said deflector displaces said sequence of images to produce a composite image composed of interleaved lines of N elements each.

3. An image projector as set forth in claim 2 wherein said source of a sequence of two dimensional images includes a spatial light modulation device for individually controlling the light intensity of each of element of each of said two dimensional images.

4. An image projector as set forth in claim 3 wherein said image projector includes a source of illumination and wherein said spatial light modulator is a transmissive device through which light passes from said source to said target.

5. An image projector as set forth in claim 3 wherein image projector includes a source of illumination and wherein said spatial light modulator is a device for reflecting light from said source onto said target.

6. An image projector as set forth in claim 2 wherein said deflector for displaying said sequence of images onto a target displaced from one another physically deflects said source of said images.

7. An image projector as set forth in claim 6 wherein said means for physically deflecting said source of said images is a piezoelectric actuator.

8. An image projector as set forth in claim 6 wherein said means for projecting said images onto a target displaced from one another comprises light deflection means for varying the direction at which light is projected onto said target.

9. An image projector as set forth in claim 8 wherein said light deflection means comprises an electrooptical light deflection device.

10. A processing and display system for a portable electronic device comprising, in combination,
a motherboard adapted to support and interconnect an integrated circuit microprocessor, one or more random access memory modules, one or more peripheral device controllers, and a graphics output controller, and
a display system comprising a light source, a spatial light modulator for controlling the intensity of light from said source at each pixel position of an image consisting of a two dimensional array of pixels, and a projector for directing said image onto a target surface, said projector including a scanner for displacing said two dimensional image in one of said dimensions to form a higher resolution image on said target.

11. A processing and display system for a portable electronic device as set forth in claim 10 wherein said two dimensional array of pixels comprises M pixels in a short dimension and N pixels in a longer dimension, and wherein said means for projecting said images onto a target displaces said images in said short dimension to produce a higher resolution image.

12. A processing and display system for a portable electronic device as set forth in claim 10 wherein said spatial light modulator is a transmissive device through which light passes from said source to said target.

13. A processing and display system for a portable electronic device as set forth in claim 10 wherein said spatial light modulator is a device for reflecting light from said source onto said target.

14. A processing and display system for a portable electronic device as set forth in claim 10 wherein said scanner includes means for physically deflecting a portion of said projector.

15. A processing and display system for a portable electronic device as set forth in claim 10 wherein said scanner includes an electrooptical light deflector for varying the direction at which light is projected onto said target.

16. A processing and display system for a portable electronic device as set forth in claim 10 wherein said target surface is a reflective screen and wherein said projector is positioned to directs said image onto said screen from the front.

17. A processing and display system for a portable electronic device as set forth in claim 10 wherein said target surface is translucent screen and wherein and wherein said projector is positioned to direct said image onto said screen from the rear of said translucent screen.

18. A processing and display system for a portable electronic device as set forth in claim 10 wherein the size of said target surface is variable and wherein said projector includes means for varying the size of the image directed onto said target surface as the size of said target surface varies.

19. A processing and display system for a portable electronic device as set forth in claim 10 wherein said projector includes at least on reflector for providing a folded optical pathway for projecting said image onto said target surface.

20. A computer comprising, in combination, a processor, a random access memory, and an image projector, said image projector comprising a source of a sequence of two dimensional images each composed of an array of M elements in a first dimension and N elements in the other dimension, where N is greater than M and where M is greater than one, and projection optics for displaying said images on a surface, said projection optics including a lens and a deflector for projecting said sequence of images from said source onto said surface displaced from one another in said first dimension.

21. A computer as set forth in claim 20 mounted within a laptop housing which further mounts an exposed keyboard and a display panel which forms said surface.

22. A computer as set forth in claim 21 wherein said lens is positioned to project said images onto said surface from a position between said keyboard and said surface.

23. A computer as set forth in claim 21 wherein said lens is positioned to project said images over said keyboard onto said surface.

24. A computer as set forth in claim 21 wherein said display panel is translucent and wherein said lens is positioned to project said images onto said surface from a position behind said display panel.
